(19) United States
(12) Patent Application Publication
(10) Pub. No.: US 2011/0055394 A1
(43) Pub. Date: Mar. 3, 2011

(54) NETWORK ASSISTED MOBILE CENTRIC PEER SELECTION METHOD

(75) Inventors: Hao Bi, Lake Zurich, IL (US); Jian Jun Wu, Reading (GB)

(73) Assignee: Motorola, Inc., Schaumburg, IL (US)

(21) Appl. No.: 12/549,602

(22) Filed: Aug. 28, 2009

(51) Int. Cl. G06F 15/173

(52) U.S. Cl. 709/226

(57) ABSTRACT

A method, a mobile system, and a mobile network operator are disclosed. A transceiver 302 may send an identity of at least one peer of a peer-to-peer content distribution network 400 to a mobile network operator 106. The transceiver 302 may receive a network provided ranking 862 of the at least one peer of the peer-to-peer content distribution network 400 from the mobile network operator 106. A processor 304 may select a peer-to-peer partner based on the network provided ranking 862.

### FIELD OF THE INVENTION

The present invention relates to a method and system for executing a peer-to-peer transfer of a data file. The present invention further relates to selecting a peer-to-peer partner for a mobile system based on a network provided ranking.

### INTRODUCTION

Peer-to-peer (P2P) technologies may apply distributed network architecture to content distribution, allowing pieces of a file to be retrieved by the participants from different network nodes. Moreover, while retrieving data of a file from other network nodes, each participant of the P2P content distribution network may contribute a portion of its resources to being a network node, such as disk storage, network bandwidth, and computing power. The participant may transmit to other participants those pieces of the file the participant already possesses. Hence, participants of the P2P content distribution play an equal role in exchanging data among themselves, as peers trading data with each other.

P2P content distribution network may typically be formed dynamically by ad-hoc addition of users, who are joining to retrieve a file. When a user wants to download a file, the user may contact a tracker, who keeps track of the users participating in the distribution of the specific file. The tracker may provide the user with a list of peers, from whom the user may download pieces of the file. The user may then send those peers a greeting message, or handshake, telling those peers that the user wants to retrieve data of the specific file. The peers may respond with a message detailing the pieces of the file they possess. The user may then send requests to some selected peers, specifying the pieces of the file to be received from them. Those peers may then send the user those requested pieces. The user may maintain regular communications with the tracker to have the up-to-date list of peers, and with the peers to have the update of their possession of the file data. As more users arrive and participate in the content distribution, pieces of the file may be well distributed among those participants, with the possibility that any piece of the file may be possessed by multiple participants. Hence, a user may have choice of selecting which peer to request a specific file piece.

### SUMMARY OF THE INVENTION

A method, a mobile system, and a mobile network operator are disclosed. A transceiver may send an identity of at least one peer of a peer-to-peer content distribution network to a mobile network operator. The transceiver may receive a network provided ranking of the at least one peer of the peer-to-peer content distribution network from the mobile network operator. A processor may select a peer-to-peer partner based on the network provided ranking.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a communication system.

FIG. 2 illustrates a possible configuration of a computing system to act as a base transceiver station.

FIG. 3 illustrates, in a block diagram, one embodiment of a mobile system or electronic device to create a radio connection.

FIG. 4 illustrates, in a block diagram, one embodiment of a peer-to-peer content distribution network.

FIGS. 5a-b illustrate, in block diagrams, an embodiment of peer-to-peer support request and response.

FIG. 6 illustrates, in a flowchart, one embodiment of accessing a peer-to-peer content distribution network via a mobile network.

FIGS. 7a-b illustrate, in block diagrams, an embodiment of a file source request and response.

FIGS. 8a-b illustrate, in block diagram, an embodiment of a network ranking request and response.

FIG. 9 illustrates, in a flowchart, one embodiment of a method for requesting a data file from the peer-to-peer content distribution network.

FIG. 10 illustrates, in a flowchart, one embodiment of a method for processing a file segment request.

FIG. 11 illustrates, in a flowchart, one embodiment of a method for processing a peer-to-peer support request.

FIG. 12 illustrates, in a flowchart, one embodiment of a method for processing a network ranking request.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, a mobile system, and a mobile network operator, and other embodiments that relate to the basic concepts of the invention. The mobile system may be any manner of computer, mobile device, or wireless communication device.

A method, a mobile system, and a mobile network operator are disclosed. A transceiver may send an identity of at least one peer of a peer-to-peer content distribution network to a mobile network operator. The transceiver may receive a network provided ranking of the at least one peer of the peer-to-peer content distribution network from the mobile network operator. A processor may select a peer-to-peer partner based on the network provided ranking.

Peer-to-peer (P2P) technologies may be used for file sharing and streaming services over the internet. Seventy percent of current internet traffic may be contributed by P2P applications. As mobile terminals get more computing power, expanded storage, QWERTY keyboards, better and larger screens, and increased radio bit rate, more mobile services may follow the trend of the fixed-line internet, causing P2P applications to proliferate and contribute a dominant share of traffic on the network.

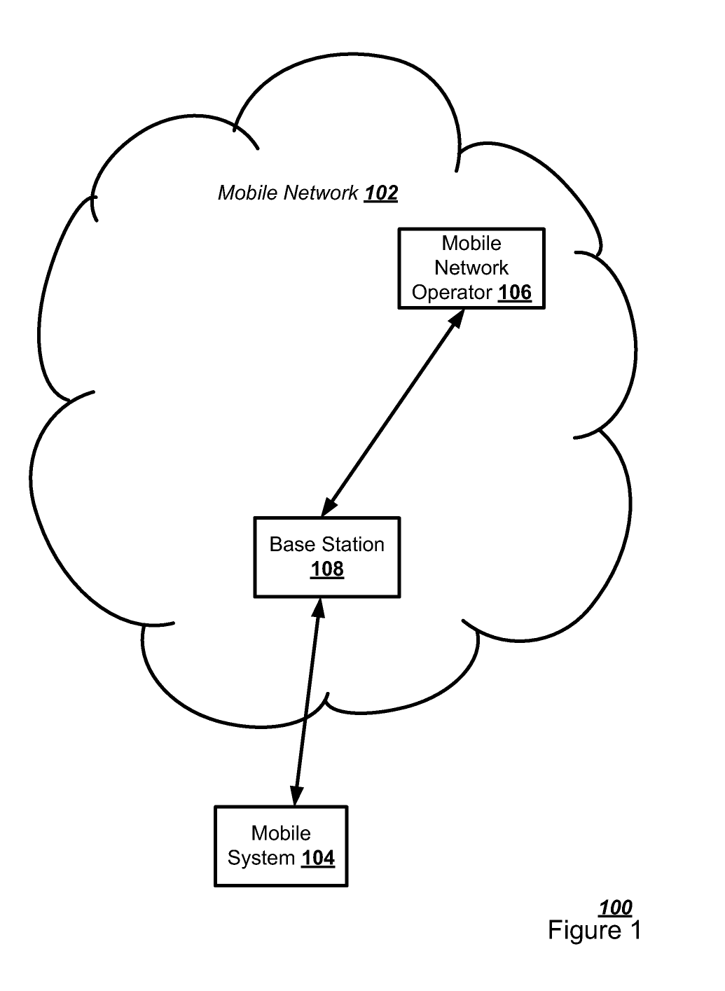

FIG. 1 illustrates one embodiment of a communication system 100. The communication system 100 may include a core mobile network 102 that may be accessed by at least one mobile device 104, such as an electronic device, mobile system, or user equipment (UE). Various communication devices may exchange data or information through the core mobile network 102. The core mobile network 102 may be a WiMAX network, a universal terrestrial radio access network (UTRAN) cellular network, an evolved UTRAN (E-UTRAN) cellular network, or other type of telecommunication network. A server or a series of servers controlled by a network operator, referred to herein as a network operator server 106, or a mobile network operator 106, may administer the network. The network operator server 106 may maintain a set of data to facilitate access of the core mobile network 102 by the mobile system 104. The mobile system 104 may access the network via a network base station 108.

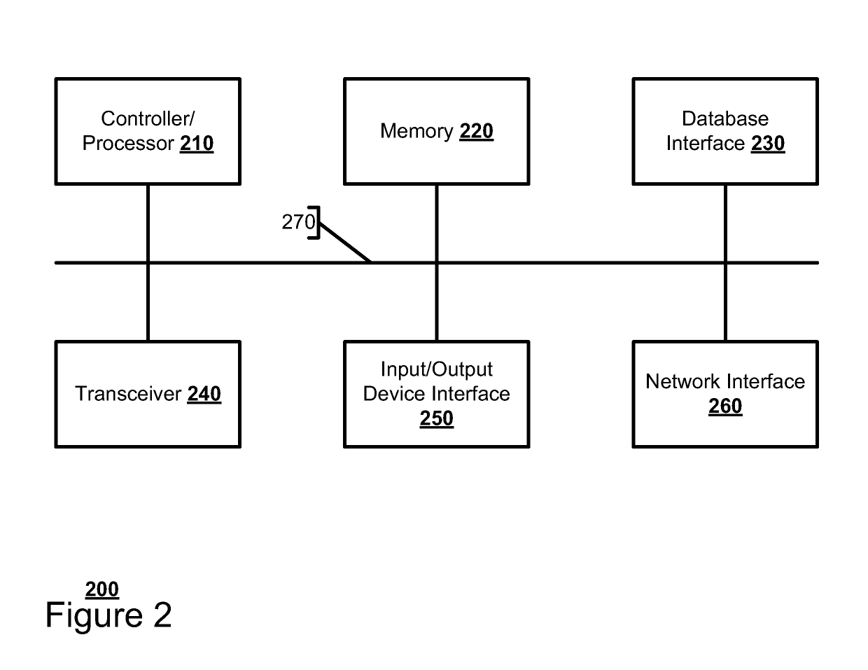

FIG. 2 illustrates a possible configuration of a computing system 200 to act as a network operator server 106 or a network base station 108. The computing system 200 may include a controller/processor 210, a memory 220, a database interface 230, a transceiver 240, input/output (I/O) device interface 250, and a network interface 260, connected through bus 270. The network server 200 may implement any operating system. Client and server software may be written in any programming language, such as C, C++, Java or Visual Basic, for example. The server software may run on an application framework, such as, for example, a Java® server or .NET® framework

The controller/processor 210 may be any programmed processor known to one of skill in the art. However, the disclosed method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the disclosed method as described herein may be used to implement the disclosed system functions of this invention.

The memory 220 may include volatile and nonvolatile data storage, including one or more electrical, magnetic or optical memories such as a random access memory (RAM), cache, hard drive, or other memory device. The memory may have a cache to speed access to specific data. The memory 220 may also be connected to a compact disc-read only memory (CD-ROM), digital video disc-read only memory (DVD-ROM), DVD read write input, tape drive, or other removable memory device that allows media content to be directly uploaded into the system.

Data may be stored in the memory or in a separate database. The database interface 230 may be used by the controller/processor 210 to access the database. The database may contain subscriber information for each mobile system 104 that may access the mobile network 102. Further, the database may maintain network performance data, such as network topology, network geographic location and peer proximity, network load distribution, and other network data.

The transceiver 240 may create a connection with the mobile device 104. The transceiver 240 may be incorporated into a base station 200 or may be a separate device.

The I/O device interface 250 may be connected to one or more input devices that may include a keyboard, mouse, pen-operated touch screen or monitor, voice-recognition device, or any other device that accepts input. The I/O device interface 250 may also be connected to one or more output devices, such as a monitor, printer, disk drive, speakers, or any other device provided to output data. The I/O device interface 250 may receive a data task or connection criteria from a network administrator.

The network connection interface 260 may be connected to a communication device, modem, network interface card, a transceiver, or any other device capable of transmitting and receiving signals from the network. The network connection interface 260 may be used to connect a client device to a network. The components of the network server 200 may be connected via an electrical bus 270, for example, or linked wirelessly.

Client software and databases may be accessed by the controller/processor 210 from memory 220, and may include, for example, database applications, word processing applications, as well as components that embody the disclosed functionality of the present invention. The network server 200 may implement any operating system. Client and server software may be written in any programming language. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

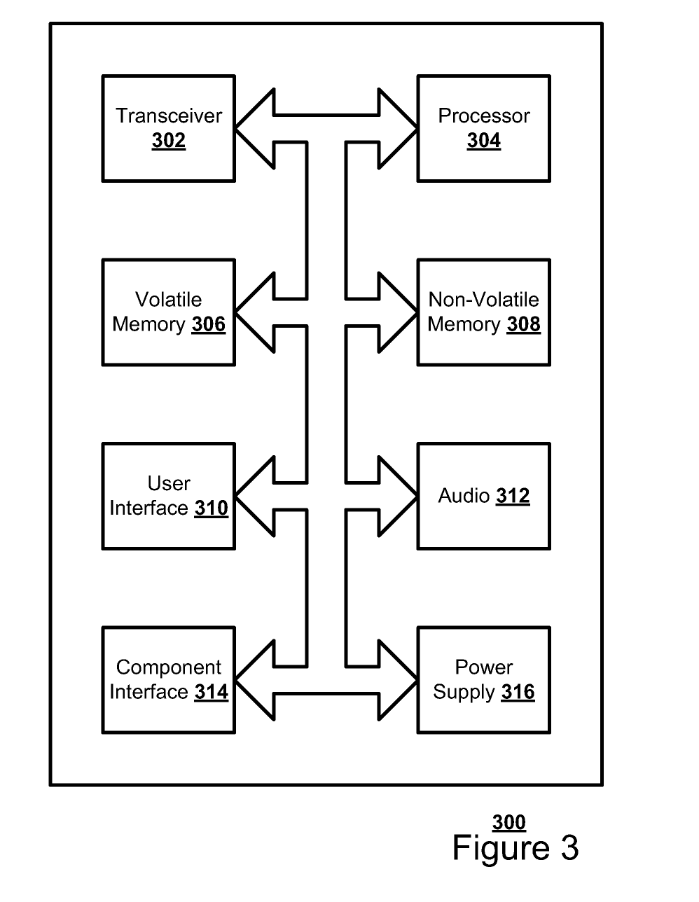

FIG. 3 illustrates one embodiment of a mobile device 300, capable of acting as a mobile system or electronic device. For some embodiments of the present invention, the mobile device 300 may also support one or more applications for performing various communications with a network. The mobile device 300 may be a handheld device, such as, a mobile phone, a laptop, or a personal digital assistant (PDA). For some embodiments of the present invention, the user device 300 may be WiFi® capable device, which may be used to access the network mobile for data or by voice using VOIP.

The mobile device 300 may include a transceiver 302, which is capable of sending and receiving data over the mobile network 102. The mobile device 300 may include a processor 304 that executes stored programs. The mobile device 300 may also include a volatile memory 306 and a non-volatile memory 308 to act as data storage for the processor 304. The mobile device 300 may include a user input interface 310 that may comprise elements such as a keypad, display, touch screen, and the like. The mobile device 300 may also include a user output device that may comprise a display screen and an audio interface 312 that may comprise elements such as a microphone, earphone, and speaker. The mobile device 300 also may include a component interface 314 to which additional elements may be attached, for example, a universal serial bus (USB) interface or a geographical positioning system (GPS). Finally, the mobile device 300 may include a power supply 316.

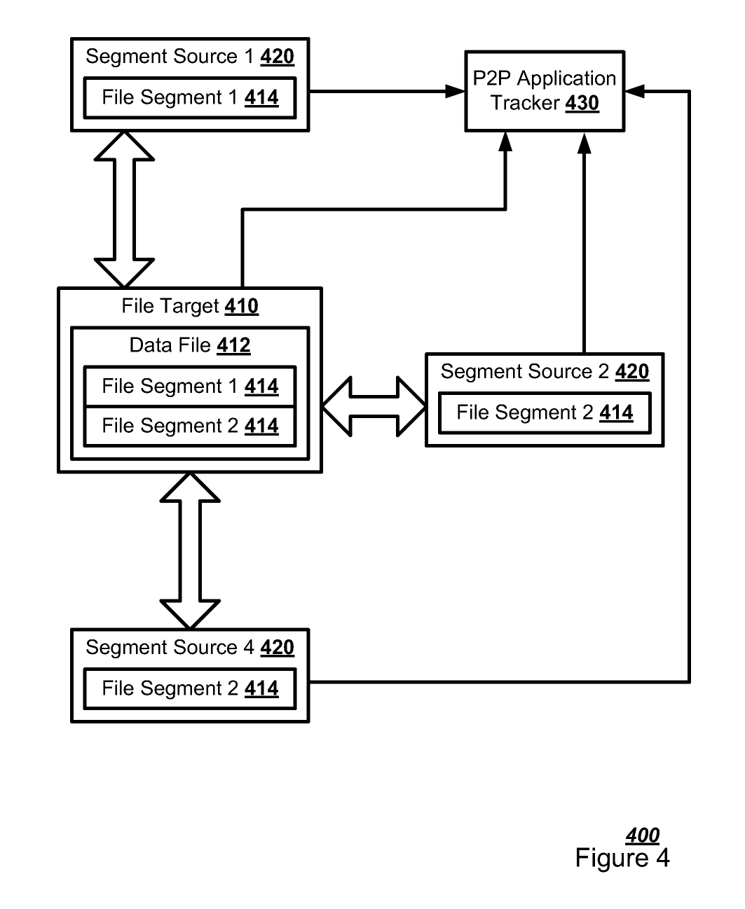

A mobile network 102 may be used to support a P2P content distribution network. FIG. 4 illustrates, in a block diagram, one embodiment of a P2P content distribution network 400. As explained above, in a P2P content distribution network 400, a file target 410 may seek to acquire a data file 412. A data file 412 may be any set of data, including a video, an audio clip, text, an application, or any set of data. The data file 412 may be divided into a set of data file segments 414 and distributed among a set of segment sources 420. The file target 410 may access the segment sources 420 to download the file segments 414, allowing for a faster and more efficient download than a single point download from a server. The file target 410 may then reassemble the data file 412. Often, the file target 410 may act as a segment source 420 for a different data file or even the same data file 410 when that file is requested by a different file target 410. Multiple copies of a single file segment 414 may reside in more than one segment source 420.

A P2P application tracker 430 may monitor the P2P file transfers and track which segment sources 420 are storing file segments 414 of the data file 412. The file target 410 may contact the P2P application tracker 430 to determine which segment sources 420 have the file segments 414 of the desired data file 412.

A mobile system 104 may act as either a segment source 420 or a file target 410. Other networks nodes, such as other users, servers, or terminals, may act as either a segment source 420 or a file target 410. Both the file target 410 and the segment source 420 may be referred to as a peer-to-peer partner. The P2P application tracker 430 may be executed on a server or terminal in the mobile network 102, or may be in an external network accessible by the user.

Instead of passively letting P2P applications use the mobile network 102 as a “dumb pipe”, a mobile network operator 106 may play a more active role in optimizing the traffic flow in the mobile network 102 for the enormous data generated by the P2P applications. This optimization may provide subscribers with a better user experience for file sharing and streaming services. Also, this optimization may reduce the traffic load through the mobile network 102 and increase the speed of file downloading or media streaming.

The peer selection strategy may be improved for P2P applications by taking into account the location of the peers and the network topology. By not blindly or inefficiently pairing peers, such as peers at opposite ends of a network, the mobile network operator 106 may achieve savings by reducing the passing-through traffic. Further, the user may have a better experience by reducing the latency of file downloading or content distribution.

In a network assisted mobile centric approach, a mobile system 104 may make a peer selection decision after requesting information from the P2P application tracker 430, such as peers who are streaming the same media content, and requesting the network to rank potential peers based on one or more network ranking factors, such as peers' location, network topology, and load distribution over the network.

The mobile system 104 may contact the P2P application tracker 430 and receive a list of peer identities, often in the form of internet protocol (IP) addresses, to retrieve segments 414 of a file 412. The mobile system 104 may contact those peers to get information on what pieces of the file 412 they have acquired. A specific file segment 414 may be possessed by multiple peers, or segment sources 420. The mobile system 104 may send the mobile network operator 106 a list of peer identities, such as a list of IP addresses, and request the mobile network operator 106 to rank them accordingly. The mobile system 104 may provide just the peer identities, hiding other application related information from the mobile network operator 106. The mobile network operator 106 may rank these peer identities based on a variety of network ranking factors, such as geographic locations, network topology, network load distribution, and other network operational data. The mobile network operator 106 may send the ranking information back to the mobile system 104. The mobile network operator 106 may provide just numerical rankings, keeping proprietary the information on the actual network topology and load distribution. For a file segment 414, the mobile system weighs the network provided ranking to select the peer, such as selecting a P2P partner based on the rules of “shortest distance” or “lightest load”. The mobile system 106 may send requests to the selected peers, or segment sources 420, to retrieve the specific file segments 414.

Network assisted mobile centric peer selection may be developed as an add-on feature on top of the normal P2P applications. Before applying, the mobile system 104 may send a signaling to the mobile network operator 106, asking if the mobile network 102 may support this feature by providing ranking information on a list of peer identities. The mobile network operator 106 may respond with another signaling indicating if this feature is supported or not. If so, the mobile network operator 106 may possibly indicate factors the network provided ranking is based on. For example, the network provided ranking may be based on the distance between the mobile system 104 and the peer, the network domains the mobile system 104 and the peer belong to, or the network load distributions along the paths between the mobile system 104 and the peer.

With a mobile centric approach, the mobile system 104 decouples the dependence between the application provider and the mobile network operator 106. The mobile network operator 106 and the application provider may operate their systems independently. The mobile system 104 may make a peer selection taking into account the input from the P2P application provider and the mobile network operator 106.

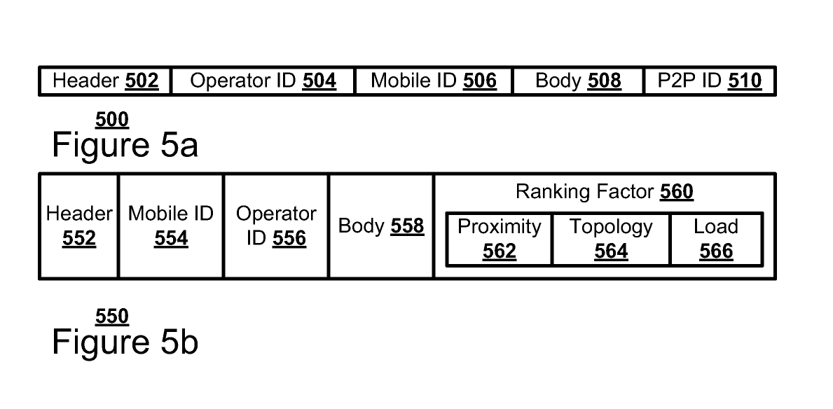

A mobile system 104 may determine if a mobile centric peer selection is viable when first accessing the mobile network. FIG. 5a illustrates one embodiment of a P2P support request 500. The P2P support request 500 may be appended onto other messages between the mobile system 104 and the mobile network operator 106. The P2P support request 500 may have a header 502 to indicate a route and a destination for the message. The P2P support request 500 may have an operator identifier (ID) 504 for the mobile network operator 106 and a mobile ID 506 for the mobile system 104. The P2P support request 500 may have a body 508 that contains the request for ranking support for P2P data transfers. The P2P support request 500 may have a P2P ID 510 for the P2P application provider. The mobile network 106 may generically provide ranking information and may not need to know the P2P application provider, although specific ranking factors may be used in conjunction with specialized P2P application service, such as emphasizing network load distribution for data heavy files.

FIG. 5b illustrates one embodiment of a P2P support response 550. The P2P support response 550 may be appended onto other messages between the mobile system 104 and the mobile network operator 106. The P2P support response 550 may have a header 552 to indicate a route and a destination for the message. The P2P support response 550 may have a mobile ID 554 for the mobile system 104 and an operator ID 556 for the mobile network operator 106. The P2P support response 550 may have a body 558 that indicates whether the mobile network operator 106 supports network provided ranking for P2P file transfers. The P2P support response 550 may have at least one network ranking factor used by the mobile network operator 106 to generate a network provided ranking for a peer of a P2P content distribution network 400. The network ranking factor 560 may be the proximity 562 of the peer to the mobile system 104, the network topology 564, the network load distribution 566 between the peer and the mobile system 104, and other network performance data.

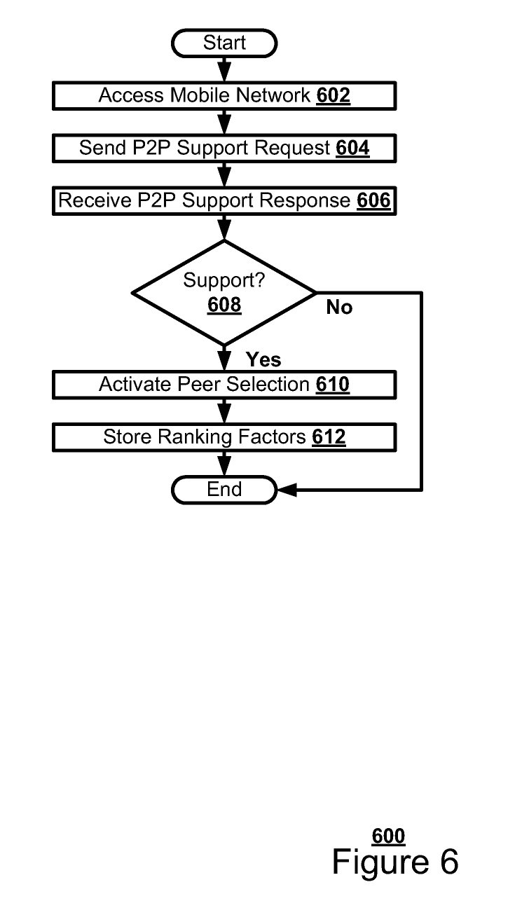

FIG. 6 illustrates one embodiment of accessing a peer-to-peer content distribution network via a mobile network. The mobile system 104 may access the mobile network 102 (Block 602). The mobile system 104 may send a P2P support request 500 to the mobile network operator 106 (Block 604). The mobile system 104 may receive a P2P support response 550 containing at least one network ranking factor 560 from the mobile network operator 106 (Block 606). If the mobile network 102 supports peer ranking for P2P file transfer (Block 608), the mobile system 104 may activate the peer selection functionality for the P2P application (Block 610). The mobile system 104 may store the network ranking factors 560 received in the P2P support response 550 (Block 612).

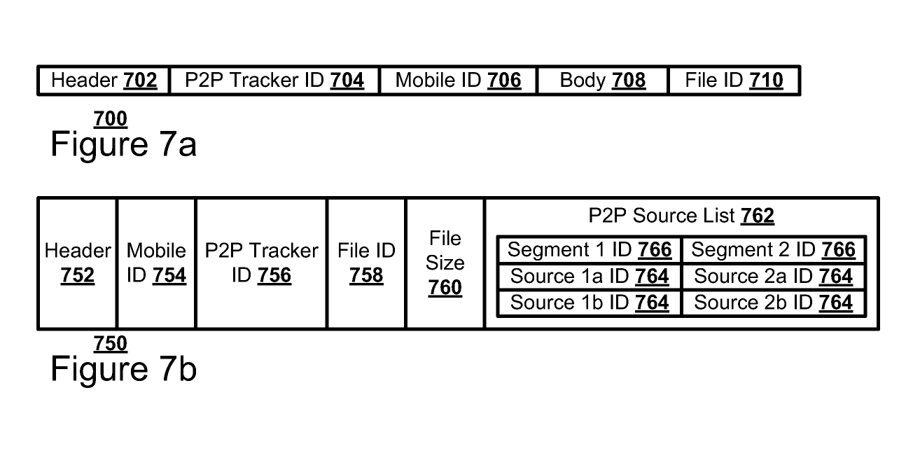

The mobile system 104 may use the file source request to request from a P2P application tracker 430 at least one segment source associated with a desired data file. FIG. 7a illustrates one embodiment of a file source request 700. The file source request 700 may be appended onto other messages between the mobile system 104 and the P2P application tracker 430. The file source request 700 may have a header 702 to indicate a route and a destination for the message. The file source request 700 may have a P2P tracker ID 704 for the P2P application tracker 430 and a mobile ID 706 for the mobile system 104. The file source request 700 may have a body 708 indicating a request for a list of content distribution network peers that may act as segment sources 420 for a specific data file 412. The file source request 700 may have a file ID 710 indicating the desired data file 412.

The P2P application tracker 430 may use a file source response to send an identity of at least one peer of the P2P content distribution network to the mobile system 104. FIG. 7b illustrates one embodiment of a file source response 750. The file source response 750 may be appended onto other messages between the mobile system 104 and the P2P application tracker 430. The file source response 750 may have a header 752 to indicate a route and a destination for the message. The file source response 750 may have a mobile ID 754 for the mobile system 104 and a P2P tracker ID 756 for the P2P application tracker 430. The file source response 750 may have a file ID 758 indicating the referenced data file 412. The file source response 750 may have a file size 760 indicating the number of data file segments 414 that a data file 412 has. The file source response 750 may have a P2P source list 762 identifying at least one peer of the P2P content distribution network 400 that may act as a segment source 420 for the data file 412. The P2P source list 762 may list the source IDs 764 for each segment source 420 associated with a data file 412. The mobile system 104 may then contact those segment sources 420 to determine which data file segment 414 they have. Alternatively, the P2P source list 762 may associate a source ID 764 with a segment ID 766 indicating the data file segment 414 stored by that segment source 420.

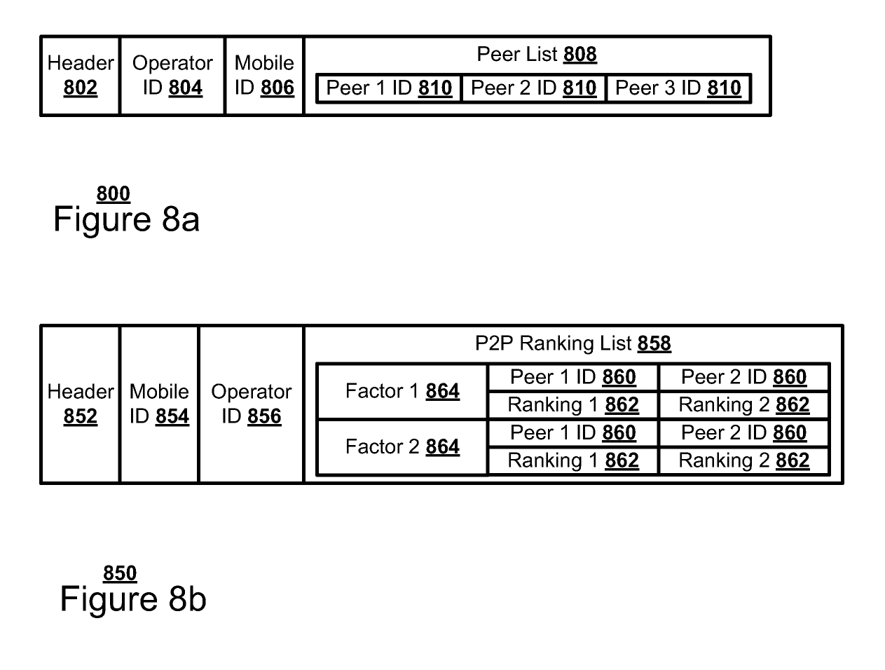

Once the mobile system 104 has obtained a list of the content distribution network peers that the mobile system 104 may want to execute a P2P transfer with, it may ask the mobile network operator 106 to provide a ranking of some or all of them. FIG. 8a illustrates one embodiment of a network ranking request 800. The network ranking request 800 may be appended onto other messages between the mobile system 104 and the mobile network operator 106. The network ranking request 800 may have a header 802 to indicate a route and a destination for the message. The network ranking request 800 may have an operator identifier (ID) 804 for the mobile network operator 106 and a mobile ID 806 for the mobile system 104. The network ranking request 800 may have a peer list 808 that includes the peer IDs 810 for any peer that may act as a segment source 420 or a file target 410 for the mobile system 104. Alternately, the peer list 808 may include the peer IDs 810 for any group of subscribers to the P2P application provider, to pre-load the rankings before a file is selected.

FIG. 8b illustrates one embodiment of a network ranking response 850. The network ranking response 850 may be appended onto other messages between the mobile system 104 and the mobile network operator 106. The network ranking response 850 may have a header 852 to indicate a route and a destination for the message. The network ranking response 850 may have a mobile ID 854 for the mobile system 104 and an operator ID 856 for the mobile network operator 106. The network ranking response 850 may have a P2P ranking list 858, indicating for each peer ID 860 a network provided ranking 862. The network provided ranking 862 may be a ranking indicating a sorting of the peers submitted in the peer list 808. Alternately, the network provided ranking 862 may be a value indicating the ranking of the peer on an absolute scale, so that peers being ranked in multiple network ranking responses may be sorted together. The network ranking response 850 may identify at least one network ranking factor 864 used in generating this network provided ranking 862. The network ranking response 850 may provide multiple network provided rankings 862 based on different network ranking factors 864.

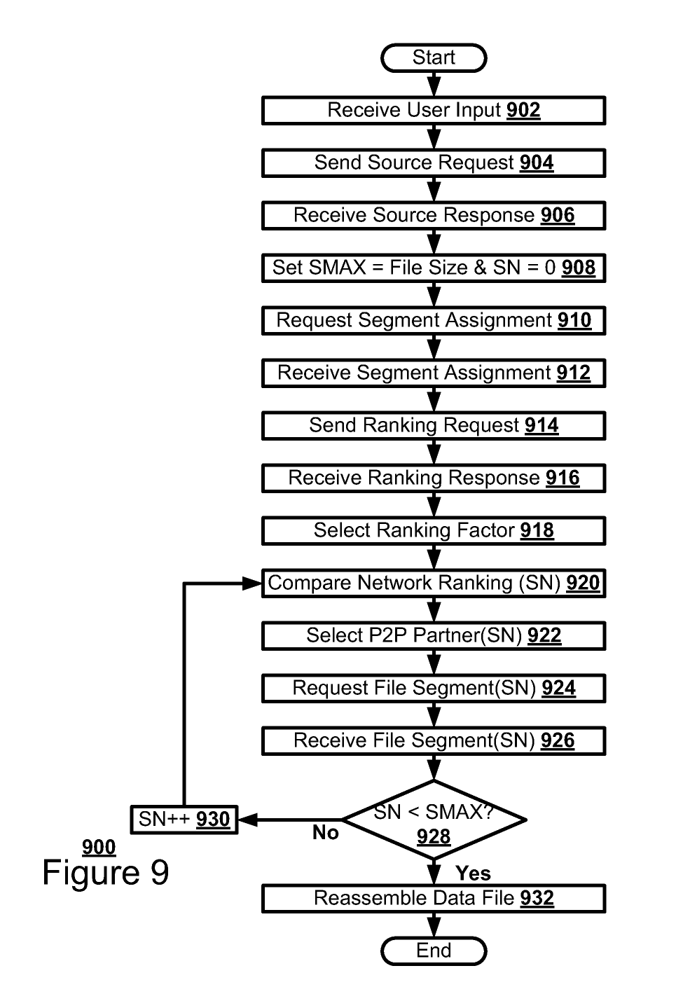

The mobile system 104 may use the network provided ranking 862 to decide between a first segment source 420 of a data file segment 414 and a second segment source 420 of the data file segment 414. FIG. 9 illustrates one embodiment of a method 900 for receiving a data file 412 from the peer-to-peer content distribution network. For purposes of simplicity and clarity, the following example describes the mobile system 104 receiving the data file segments 414 sequentially, when in actuality the mobile system 104 may receive the data file segments concurrently. The mobile system 104 may receive a user input indicating a data file that the user wishes to download (Block 902). The mobile system 104 may send a file source request 700 to the P2P application tracker 430 (Block 904). The mobile system 104 may receive a file source response 750 from the P2P application tracker 430 (Block 906). The mobile system 104 may initialize a segment counter (SN) to zero and set an upper bound (SMAX) for that segment counter to the file size 760 (Block 908). The mobile system 104 may request from each content distribution network peer listed in the data source response 750 a segment assignment indicating which data file segment 414 is stored with that content distribution network peer (Block 910). The mobile system 104 may receive that segment assignment from the contacted content distribution network peers. The mobile system 104 may send a network ranking request 800 to the mobile network operator 106 (Block 914). The mobile system 104 may receive a network ranking response 850 from the mobile network operator 106 (Block 916). The mobile system 104 may receive one or more network ranking responses 850 having multiple network provided rankings 862 generated by the mobile network operator 106 using different sets of one or more network ranking factors 864. The mobile system 104 may select a network provided ranking 862 generated by the mobile network operator 106 using a specific set of at least one network ranking factor 864 (Block 918). The mobile system 104 may compare the network provided ranking 862 of each segment source 420 associated with data file segment SN 414 (Block 920). The mobile system 104 may select a P2P partner for data file segment SN 414 based on the network provided ranking 862 (Block 922). The mobile system 104 may request the data file segment SN 414 from the P2P partner (Block 924). The mobile system may receive the data file segment SN 414 of the data file 412 from the P2P partner (Block 926). If the segment counter SN is less than SMAX (Block 928), the mobile system may increment the segment counter SN (Block 930) and may compare the network provided ranking 862 of each segment source 420 associated with data file segment SN 414 (Block 920). If the segment counter SN is not less than SMAX (Block 928), the mobile system 104 may reassemble the data file (Block 932).

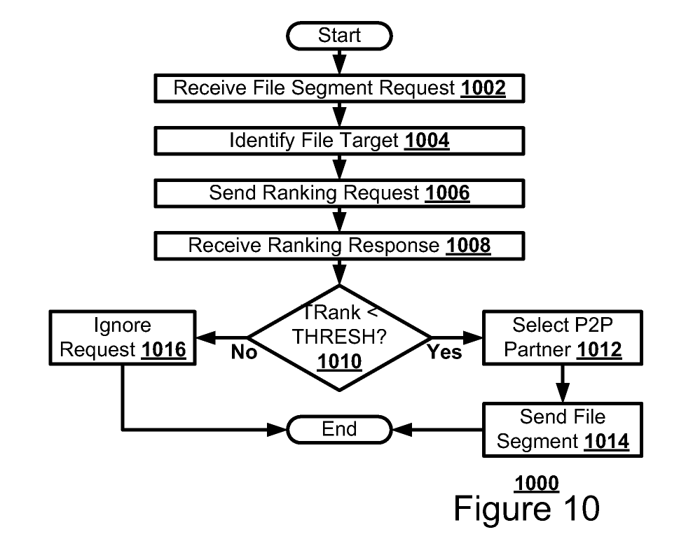

FIG. 10 illustrates one embodiment of a method 1000 for processing a file segment request. The mobile system 104 may receive a file segment request for a file segment 414 stored on the mobile system 104 (Block 1002). The mobile system 104 may identify the file target 410 that sent the file segment request (Block 1004). The mobile system 104 may receive multiple file segment requests, for the same or different file segments 414, from multiple file targets 410. The mobile system may send to the mobile network operator 106 a network ranking request 800 having the peer ID 810 for at least one file target 410 (Block 1006). The mobile system 104 may receive from the mobile network operator 106 a network ranking response 850 having a network provided ranking 862 (TRank) for the at least one file target 410 (Block 1008). If the network provided ranking 862 is less than a pre-set threshold level (THRESH) (Block 1010), the mobile system 104 may select the file target 410 as a P2P partner (Block 1012). The mobile system 104 may send the stored data file segment 414 to the file target 410 (Block 1014). If the network provided ranking 862 is not less than a pre-set threshold level (Block 1010), the mobile system 104 may ignore the file segment request (Block 1016). Alternatively, the mobile system 104 may compare the network provided rankings 862 of multiple file targets 410 included in the network ranking responses 850. The mobile system 104 may select among the file targets 410 based on the network provided rankings 862. The mobile system 104 may send the data file segment 414 requested by the selected file targets 410.

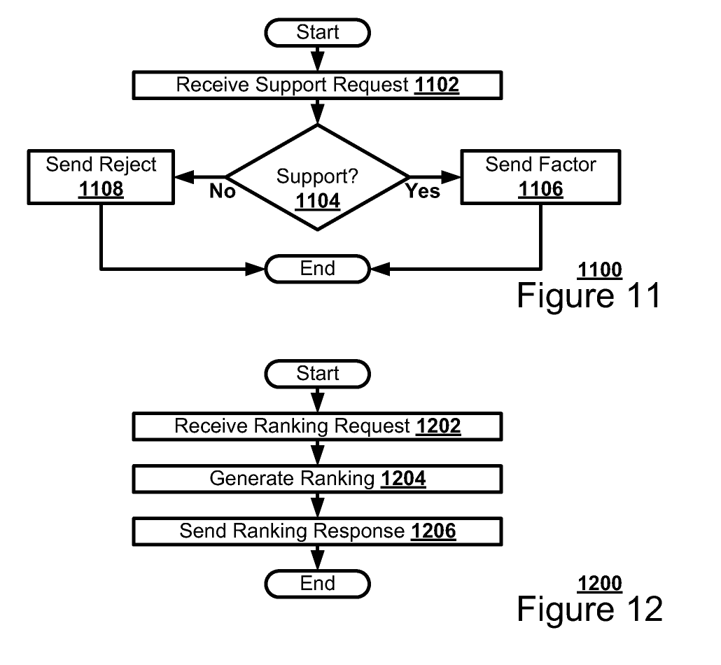

FIG. 11 illustrates one embodiment of a method 1100 for processing a P2P support request. The mobile network operator 106 may receive a P2P support request 500 from a mobile system 104 (Block 1102). If the mobile network 102 supports network ranking of peers (Block 1104), the mobile network operator 106 may send the mobile system 104 a P2P support response 550. The P2P support response 550 may include at least one network ranking factor used to generate a network provided ranking 862 (Block 1106). If the mobile network 102 does not support network ranking of peers (Block 1104), the mobile network operator 106 may send a P2P support response 550 with a rejection message in the body 558 of the P2P support response 550 (Block 1108).

FIG. 12 illustrates one embodiment of a method 1200 for processing a network ranking request. The mobile network operator 106 may receive from the mobile system 104 a network ranking request 800 having at least one peer ID 810 representing a peer of a P2P content distribution network (Block 1202). The mobile network operator 106 may generate a network provided ranking 862 for the at least one peer of a P2P content distribution network 400 based on at least one network ranking factor 580 (Block 1204). The mobile network operator 106 may send the mobile system 104 a network ranking response 850 having a network provided ranking 862 of the at least one peer of the P2P content distribution network 400 (Block 1206).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for peer-to-peer transfer of a data file, comprising:
sending an identity of at least one peer of a peer-to-peer content distribution network to a mobile network operator;
receiving a network provided ranking of the at least one peer of the peer-to-peer content distribution network from the mobile network operator; and
selecting a peer-to-peer partner based on the network provided ranking.

2. The method of claim 1, further comprising:
transferring a data file segment of the data file to the peer-to-peer partner.

3. The method of claim 1, further comprising:
receiving a data file segment of the data file from the peer-to-peer partner.

4. The method of claim 1, further comprising:
sending a peer-to-peer support request to the mobile network operator.

5. The method of claim 1, further comprising:
receiving from the mobile network operator at least one network ranking factor.

6. The method of claim 1, wherein the network provided ranking is based on at least one of peer proximity, network topology, and network load distribution.

7. The method of claim 1, further comprising:
requesting from a peer-to-peer application tracker at least one segment source associated with the data file; and
receiving the identity of the at least one peer of the peer-to-peer content distribution network.

8. The method of claim 1, further comprising:
selecting between a first segment source of a data file segment of the data file and a second segment source of the data file segment of the data file.

9. A mobile system for peer-to-peer transfer of a data file, comprising:
a transceiver that sends an identity of at least one peer of a peer-to-peer content distribution network to a mobile network operator and receives a network provided ranking of the at least one peer of the peer-to-peer content distribution network from the mobile network operator; and
a processor that selects a peer-to-peer partner based on the network provided ranking.

10. The mobile system of claim 9, wherein the transceiver sends a data file segment of the data file to the peer-to-peer partner.

11. The mobile system of claim 9, wherein the transceiver receives a data file segment of the data file from the peer-to-peer partner.

12. The mobile system of claim 9, wherein the transceiver sends a peer-to-peer support request to the mobile network operator.

13. The mobile system of claim 9, wherein the transceiver receives from the mobile network operator at least one network ranking factor.

14. The mobile system of claim 9, wherein the network provided ranking is based on at least one of peer proximity, network topology, and network load distribution.

15. The mobile system of claim 9, wherein the transceiver requests from a peer-to-peer application tracker at least one segment source associated with the data file and receives the identity of the at least one peer of the peer-to-peer content distribution network.

16. The mobile system of claim 9, wherein the processor selects between a first segment source of a data file segment of the data file and a second segment source of the data file segment of the data file.

17. A mobile network operator for peer-to-peer transfer of a data file, comprising:
a network interface to receive an identity of at least one peer of a peer-to-peer content distribution network from a mobile system and send a network provided ranking of the at least one peer of the peer-to-peer content distribution network to the mobile system; and
a processor to generate the network provided ranking for the at least one peer of a peer-to-peer content distribution network based on at least one network ranking factor.

18. The mobile network operator of claim 17, wherein the network interface receives a peer-to-peer support request from the mobile system.

19. The mobile network operator of claim 17, wherein the network interface sends the at least one network ranking factor to the mobile system.

20. The mobile network operator of claim 17, wherein the at least one network ranking factor is one of peer proximity, network topology, and network load distribution.
